(19) United States
(12) Patent Application Publication
(10) Pub. No.: US 2001/0019303 A1
(43) Pub. Date: Sep. 6, 2001

(54) Method for transmission of data

(76) Inventors: Michael Bruhnke, Muenchen (DE); Ulrich Friedrich, Ellhofen (DE); Marc Melchior, Hohenkammer (DE); Andreas Schuelgen, Muenchen (DE)

Correspondence Address: FASSE PATENT ATTORNEYS, P.A., P.O. BOX 726, HAMPDEN, ME, 04444-0726, US

(21) Appl. No.: 09/785,832

(22) Filed: Feb. 16, 2001

(30) Foreign Application Priority Data
Mar. 3, 2000 (DE) 100 10 585. 8

(51) Int. Cl. H04Q 5/22

(52) U.S. Cl. 340/10.4; 340/10.2; 340/10.3; 340/10.42

(57) ABSTRACT

The invention relates to a method for transmitting data in a system comprising a reader that creates an interrogation field which contains at least two transponders that, after a start signal has been given in the interrogation field, transmit through load modulation of the interrogation field a uniquely assigned bit sequence back to the reader.

For fast and reliable identification of all transponders in the interrogation field, precisely one time slot for time modulation is provided for each possible significance of each bit position of the bit sequence to be transmitted. The transponders cease transmitting their bit sequence when they detect loading modulation in a time slot in which they themselves have not actively modulated the interrogation field by loading. After complete transmission of the uniquely assigned bit sequence of a transponder, this transponder is deactivated and the procedure is repeated with the other transponders in the interrogation field by again sending the start signal. The procedure is repeated until no further loading modulation takes place in all time slots of the first bit position.

The particular distinguishing feature of the method is that for N transponders only N+1 interrogation cycles are needed to identify all transponders and that the entire value set available for the bit sequence can be allocated as identifier. Even transponders that come into the interrogation field after data transmission has begun are identified.

### BACKGROUND OF THE INVENTION

The invention relates to a method for the transmission of data in a system comprising a reader that creates an interrogation field which contains at least two transponders that, after a start signal has been given in the interrogation field, transmit through load modulation of the interrogation field a uniquely assigned bit sequence back to the reader.

With such methods, the difficulty arises that the bit sequences sent by the transponders through load modulation overlay and therefore a so-called arbitration scheme is needed in order to avoid data collisions.

From U.S. Pat. No. 5,339,073 a method is known in which, for interrogating several transponders contained in the interrogation field of a reader, initially one transponder is selected for data transmission of the bit sequence uniquely assigned to it. To this end, all transponders begin to reply to a start signal in the interrogation field that have a preset value at a first position in the bit sequence. In the next step, all transponders begin to reply to a start signal in the interrogation field that have a preset value at a second position and that have also replied to the preceding interrogation. This procedure continues until a single transponder has been selected. The interrogation strategy follows, for example, a search for a binary tree structure (binary tree search).

Another method is known from EP 405 695 A1 according to which initially the frequency of the interrogation field is slightly changed in order to interrogate one of several transponders contained in the interrogation field of a reader. The transponders respond to this frequency change with a time interval in which they modulate no information onto the interrogation field. This time interval is different from one transponder to the next and also depends on the magnitude of the frequency change. At the end of the time interval, a first transponder begins with the data transmission while the others are thereby blocked. When a transponder has sent a bit sequence, it remains inactive throughout the remaining rounds.

From EP 494 114 A2 a method is known with which transponders with the same bit sequence in the interrogation field can also be recognized and registered.

The above-mentioned methods have the disadvantage that, in order to reliably identify all transponders contained in the field, numerous interrogation steps are necessary and therefore a relatively long time is needed. Furthermore, because the distances between the individual transponders and the reader differ, a collision can be identified with varying degrees of difficulty.

### SUMMARY OF THE INVENTION

The object of the invention is to specify a method for the transmission of data in a system comprising a reader that creates an interrogation field which contains at least two transponders that, after a start signal has been given in the interrogation field, transmit through load modulation of the interrogation field a uniquely assigned bit sequence back to the reader which can quickly and reliably identify all transponders in the interrogation field.

This object is solved by a method in accordance with the preamble of claim 1 in that for each possible significance of each bit position to be transmitted in the bit sequence precisely one time slot is provided for the load modulation and that the transponders cease transmission of their bit sequence that identifies a load modulation in a time slot in which they themselves have not actively modulated the interrogation field by loading.

After complete transmission of the uniquely assigned bit sequence of a transponder, this transponder is deactivated and the procedure is repeated with the other transponders in the interrogation field by again sending the start signal. The procedure is repeated again and again until no further load modulation takes place in all time slots of the first bit position.

The distinguishing feature of the method is that for N transponders only N+1 interrogation cycles are needed to identify all transponders and the entire value set available for the bit sequence can be allocated as identifier. Even transponders that come into the interrogation field after data transmission has begun are identified.

The reader sends advantageously a synchronization signal in the interrogation field to the transponder after each bit position (except for the last) to be transmitted.

In a further development of the method, after complete transmission of the bit sequence uniquely assigned to a transponder this is caused to send further data to the reader before being deactivated. It is of advantage here when the reader causes the transponder to transmit the further data by sending a request signal.

### BRIEF DESCRIPTION OF THE DRAWINGS

FIG. 1 shows a flowchart of the procedural sequence in the reader;

FIG. 2 shows the basic time structure of a protocol;

FIG. 3 shows a flowchart of the procedural sequence in the transponder.

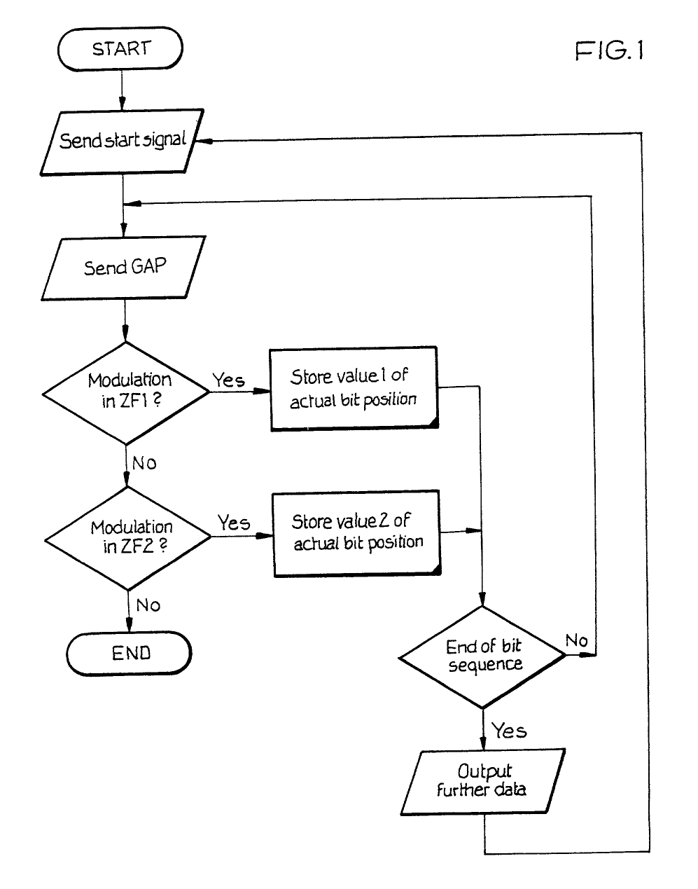

### DESCRIPTION OF THE PREFERRED EMBODIMENTS

The invention will now be described on the basis of an embodiment example with the help of the figures.

For interrogation the reader creates a high-frequency alternating field that is load-modulated by the transponders to transmit their identifier which is stored as a bit sequence. If there are several transponders in the interrogation field, their replies overlay each other so that a selection procedure is needed to recognize the identifiers. At the beginning of the procedure, a start signal is generated by the reader in the interrogation field. The start signal consists, for example, of a command to the transponders with which they are caused to prepare the transmission of their identifier. Next, the reader sends a synchronizing signal (GAP) with which the transponders synchronize their replies, i.e. all transponders attempt to begin with their reply at almost the same time. The synchronizing signal (GAP) is created by a blanking interval in the interrogation field in which the amplitude goes down to zero or a considerably reduced value.

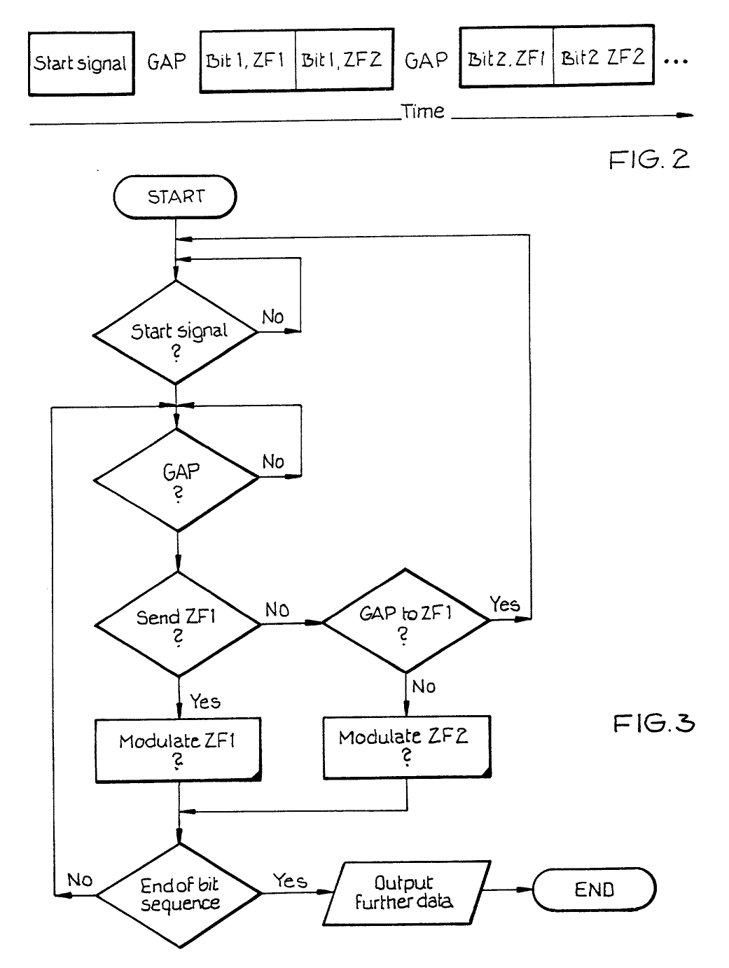

Following the synchronizing signal (GAP), the transponders have a number of time slots at their disposal in which they reply in accordance with their identifier. In accordance with the present method, provision is made for precisely one time slot to be provided for each possible significance of a bit position of the identifier stored as bit sequence. In the embodiment example, two significances are provided, namely zero and one, as shown in FIG. 2. Therefore, precisely two time slots (ZF1, ZF2) which do not overlap each other are arranged per bit position in the protocol, framed by two synchronizing signals (GAP).

All transponders which, in the first bit position, have a first significance (value1) begin in the first time slot (ZF1) with the loading modulation. All other transponders that have a second significance (value2) in the first bit position begin in the second time slot (ZF2) with the loading modulation, but only if no other transponder has modulated the field by loading in the first time slot. For this purpose, the reader sends a synchronizing signal (GAP) after it has recognized a modulation in the first time slot and in this way interrupts the transmission in the second time slot. If this is the case, all transponders that wanted to send in the second time slot remain inactive until a further start signal in the interrogation field again starts the procedure.

In the reader, the first or second significance is registered as the significance of the identified bit position, according to whether a modulation had occurred in the first or second time slot. If the entire bit sequence has not yet been identified by the reader, it sends a synchronizing signal (GAP) and thus causes all transponders that have not been deactivated to resume modulation in the respective time slots of the next bit position.

The process continues in this way until the complete bit sequence of a transponder has been received and identified by the reader. Following this, further data can be requested and output from the transponder selected by these means. Finally, the transponder is excluded from the further selection procedure so that it takes part in the procedure again only when it is requested to do so by a specific command. When a start signal is sent, all transponders that have so far not been identified again take part and after the next synchronizing signal they begin with the modulation in accordance with the significance of the first bit position in their identifier.

When all transponders have been selected and identified by the reader after a corresponding number of rounds, no transponders respond by modulation of the interrogation field after the start and synchronizing signals, neither in the first nor in the second time slot. This allows the reader to establish that there are no further transponders in the interrogation field.

If further transponders are put in the interrogation field during the ongoing selection procedure, they automatically participate in the selection procedure as from the next start signal and are selected immediately or in later rounds in accordance with the priority of their identifier which is stored as bit sequence.

The transponders are dealt with automatically in the sequence of their identifiers. Higher priority is given to identifiers having significances at the first bit positions leading to modulation in the first time slot.

What is claimed is:

1. Method for the transmission of data in a system comprising a reader that creates an interrogation field which contains at least two transponders that, after a start signal has been given in the interrogation field, transmit through load modulation of the interrogation field a uniquely assigned bit sequence back to the reader, wherein
for each possible significance or each bit position of the bit sequence to be transmitted precisely one time slot is provided for loading modulation and wherein the transponders cease transmission of their bit sequence that identifies a load modulation in a time slot in which they themselves have not actively modulated the interrogation field by loading.

2. Method in accordance with claim 1, wherein after complete transmission of the uniquely assigned bit sequence of a transponder this transponder is deactivated and the procedure is repeated with the other transponders in the interrogation field by again sending the start signal.

3. Method in accordance with claim 2, wherein the procedure is repeated until no further loading modulation takes place in all time slots of the first bit position.

4. Method in accordance with claims 1 to 3, wherein the reader sends a synchronizing signal in the interrogation field to the transponders before each bit position to be transmitted.

5. Method in accordance with claim 4, wherein the reader sends the synchronizing signal when loading modulation has taken place in the actual time slot of the bit position.

6. Method in accordance with claims 1 to 5, wherein after complete transmission of the uniquely assigned bit sequence of a transponder this transponder sends further data to the reader before it is deactivated.

7. Method in accordance with claim 6, wherein the reader causes the transponder to transmit the further data by sending a request signal.
